(19) United States
(12) Patent Application Publication
(10) Pub. No.: US 2009/0078245 A1
(43) Pub. Date: Mar. 26, 2009

(54) Gas grill apparatus with integrated modules

(75) Inventor: Saban Chang, Industry, CA (US)

Correspondence Address: Saban Chang, P.O. Box 1818, Rancho Cucamonga, CA, 91789, US

(73) Assignee: Nexgrill Industries, Inc.

(21) Appl. No.: 11/858,128

(22) Filed: Sep. 20, 2007

(51) Int. Cl. A47J 37/07

(52) U.S. Cl. 126/25 B

(57) ABSTRACT

A gas grill apparatus includes a supporting frame, a plurality of gas burners, a valve module, an ignition module, and a control module. The valve module includes a valve box supported at a rear portion of a bottom compartment of the supporting frame, a gas inlet, and a plurality of gas controlling valves for controllably guiding a gas flow from a gas source to the gas burners respectively. The ignition module includes a plurality of electrodes extended close to the gas burners respectively. The control module is actuated to control each gas controlling valve to emit said gas from said respective gas burner and, at the same time, to activate the ignition module to produce a spark at the electrode so as to ignite the gas emitting from the respective gas burner.

### BACKGROUND

1. Field of the Invention

The present invention relates to a gas grill apparatus. More particularly, the gas grill apparatus comprises a plurality of integrated modules to organize the ignition system, the valve control, and the electric circuit system to facilitate the assembling operation and to enhance the practical use of the present invention.

2. Discussion of the Related Art

A conventional gas grill comprises a frame, a firebox, a valve assembly, an ignition assembly, and a control system. The frame has a cook top and a bottom compartment receiving a gas container under the cook top, wherein one or more burners of the firebox are mounted at the cook top of the frame. The valve assembly includes a main valve connected to the gas container and a plurality of valve regulators connected to the burners respectively such that the gas stored in the gas container is controlled to flow towards one of the burners via the respective valve regulator. The ignition system generally includes a piezoelectric device and a plurality of electrodes mounted at the firebox adjacent to the burners respectively. The control system includes a front panel mounted at a front side of the frame, an ignition button provided at the front panel to actuate the piezoelectric device to produces the sparks at the electrodes respectively, and a plurality of valve switches adjusting the flow of gas through the valve regulators respectively to emit and ignite the gas from the burners.

However, the conventional gas grill has several drawbacks. Firstly, since the valve switches are mounted on the front panel, the valve regulators must be positioned right below the valve switches to connect with the gas container for minimizing the distance between the gas container and the valve switches. In addition, the ignition assembly is also disposed within the bottom compartment under the front panel. Therefore, all the valve assembly, the ignition assembly, and the control system are packed and taken up the front portion of the bottom compartment so that the gas container must be placed at the rear portion of the bottom compartment. It is worth mentioning that it is a hassle for the user to replace the gas container from the rear side of the frame.

Another drawback of the conventional gas grill is that it is unsafe for the user to stand at the front side of the frame that the user is close to the valve regulators. The valve regulators must be individually linked to the main valve as well so that the configuration of the valve assembly will increase the chance of gas leakage.

Another drawback of the conventional gas grill is another unsafe feature thereof. Accordingly, the direction of the gas is flowing from the front end of the burner to the rear end thereof because the location of each of the valve regulators. Therefore, the electrodes must be extended to the front ends of the burners to initially ignite the gas emitting at the front end thereof. It is unsafe for the user to stand at the front side of the frame close to the initial flame position of each of the burners.

Another drawback of the conventional gas grill is that since all the valve assembly, the ignition assembly, and the control system mounted the front portion of the frame, the firebox must be moved rearward for creating enough space for all the components. Therefore, the burners in the firebox must be moved further from the user standing at the front side of the frame. The user may tend to lean frontward to reach the cook top of the frame.

Another drawback of the conventional gas grill is that the assembling operation thereof is extremely complicated. All the components are individually packed in a storage box so that the user must require a certain level of skill to read the installation instruction and to assemble all the components in proper location. It is worth mentioning that the valve assembly is considered one of the most important components of the gas grill so that the improper installation of the valve assembly may cause the explosion of the gas.

### BRIEF SUMMARY OF THE INVENTION

The present invention overcomes the above mentioned drawbacks and limitation by configuring and rearranging all the components to form the integrated modules.

The primary objective of the present invention is that the gas grill apparatus comprises a plurality of integrated modules to organize the ignition system, the valve control, and the electric circuit system to facilitate the assembling operation and to enhance the practical use of the present invention. All the ignition system, the valve control, and the electric circuit system are grouped individually to form the ignition module, the valve module, and the control module. Therefore, the user is able to install each of the integrated modules without any difficulty. The user can easily connect the integrated modules with each other for easy wiring and maintenance. All wires are well-organized.

Another objective of the present invention is that each of the integrated modules provides a maximized safety feature to reduce the chance of gas leakage or the operational failure of the gas grill. The valve module is directly connected from the gas source to the firebox so that the safety regulations of the valve module are preset to prevent any improper connection. The control module is also protected to prevent overheat of the ICB (Integrated Circuit Board) and to reduce the electronic damage thereof.

The present invention also provides another objective of relocating the integrated modules to a rear side of the supporting frame. One aspect of the integrated modules being located at the rear side of the supporting frame is to create a front cavity to receive the gas container so that the user is able to easy replace or access the gas container at the front side of the supporting frame. In another aspect, the distance between the user and the valve module can be maximized when the user stands at the front side of the gas grill apparatus.

In yet another aspect, the size of the gas grill apparatus will be significantly reduced because the integrated modules are pre-installed and packed in a compact sized protection box.

In yet another aspect, the direction of the gas flowing from the rear ends of the gas burners to the front ends thereof so that the electrodes are extended to the rear ends of the burners to initially ignite the gas emitting at the rear ends thereof. Therefore, the initial ignition point of each of the gas burners is moved far away from the user.

In yet another aspect, the firebox of the gas grill apparatus is moved forwardly at a position close the user. Therefore, the user is able to easily reach and access the cooking top without leaning his or her body frontward.

In yet a further aspect, the user is able to operate the gas grill apparatus through a digit touch panel. Therefore, the user is able to controllably emit and ignite the gas from the gas burners, and to regulate the amount of gas flow by a touch of the control panel.

In yet a further aspect, the integrated modules can incorporate with any exiting gas grill apparatus including a barbeque grill and gas stove.

In yet a further aspect, the gas grill apparatus can hook up with any gas source including the LP gas container and/or natural gas.

For a more complete understanding of the present invention with its objectives and distinctive features and advantages, reference is now made to the following specification and to the accompanying drawings.

### BRIEF DESCRIPTION OF THE DRAWING(S)

FIG. 1 is a perspective view of a gas grill apparatus in accordance with the present invention.

FIG. 2 is a block diagram of the operation of the gas grill apparatus in accordance with the present invention.

FIG. 3 is a top view of the firebox of the gas grill apparatus in accordance with the present invention.

FIG. 4 is a schematic view of the valve module, the ignition module, and the control module of the gas grill apparatus in accordance with the present invention.

FIG. 5 is a schematic view of the valve module in accordance with the present invention.

FIG. 6 is a schematic view of the ignition module in accordance with the present invention.

FIG. 7 is a schematic view of the control module in accordance with the present invention.

FIG. 8 is a partially rear view of the gas grill apparatus in accordance with the present invention.

### DETAILED DESCRIPTION OF THE INVENTION

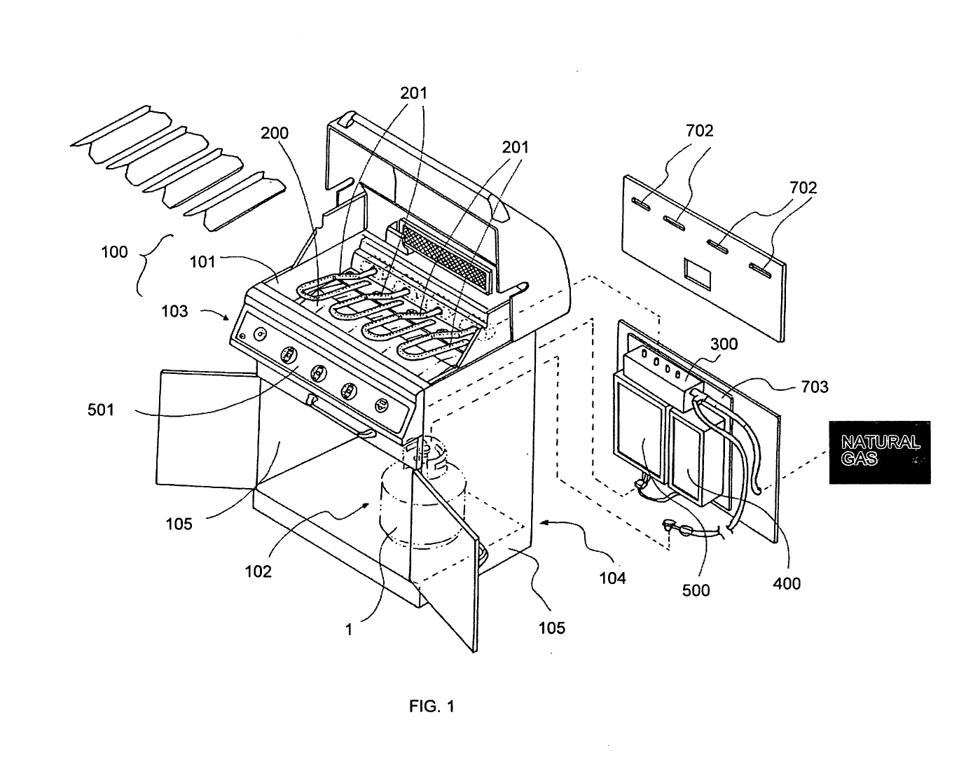

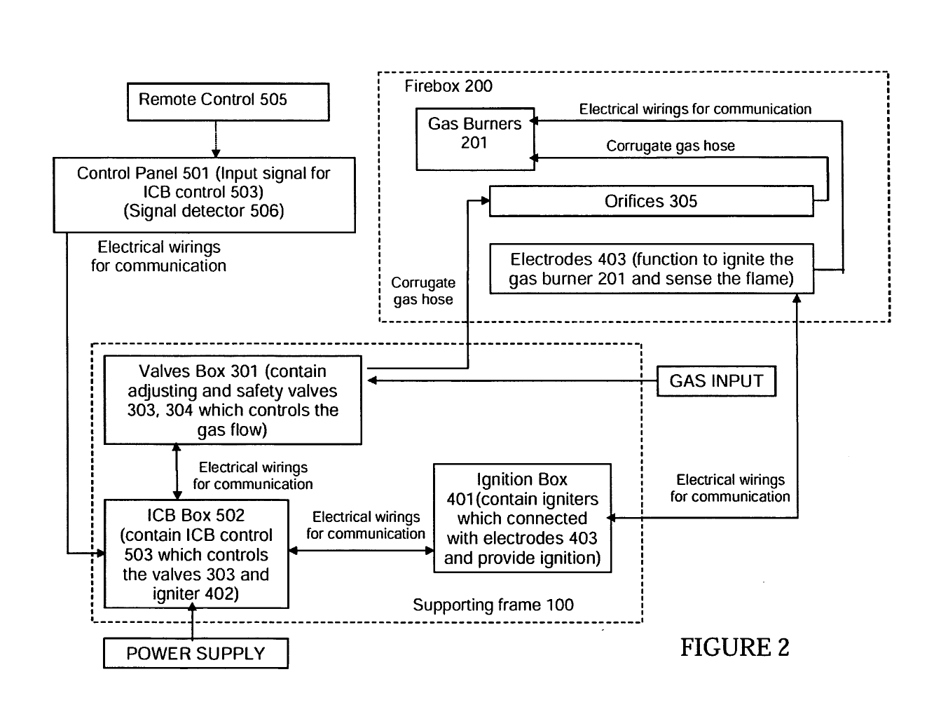

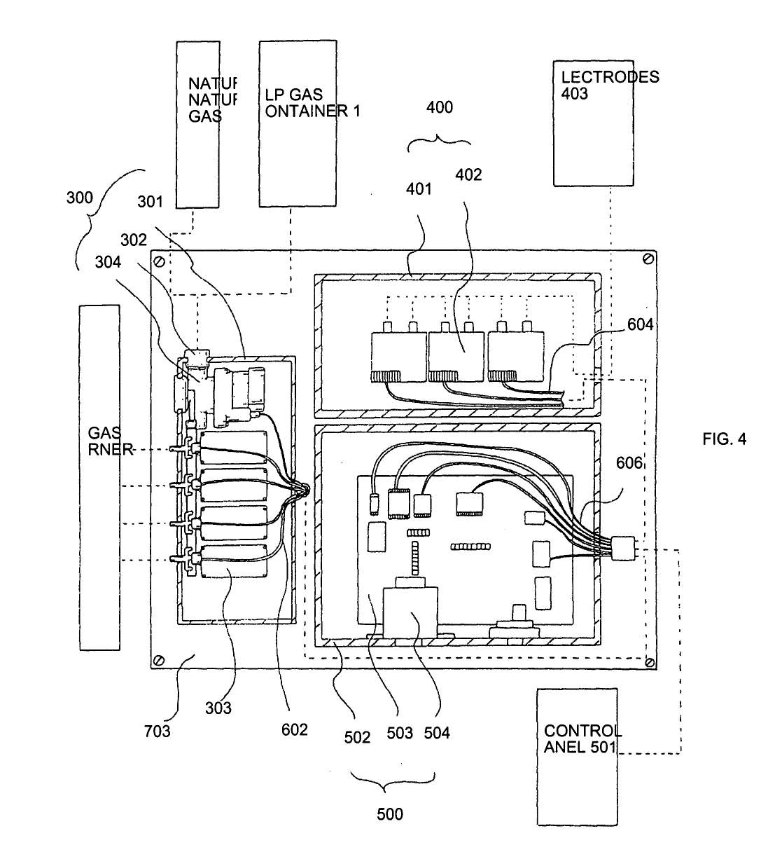

Referring to FIGS. 1 and 2, a gas grill apparatus in accordance with the present invention is illustrated. The gas grill apparatus comprises a supporting frame 100, a firebox 200 supported by the supporting frame 100, and a plurality of integrated modules. Accordingly, there are three individual integrated modules, namely a valve module 300, an ignition module 400 and a control module 500 as shown in FIG. 4. The details of the integrated modules will be described later.

As shown in FIGS. 1, 3 and 8, the supporting frame 100 has a cook top 101, a bottom compartment 102, a front side 103, a rear side 104, and two sidewalls 105. The supporting frame 100 is made of rigid and heat withstanding material such as stainless steel. The firebox 200 is supported by the supporting frame 100 wherein the firebox 200 comprises a plurality of gas burners 201 supported at the cook top 101 of the supporting frame 100 above the bottom compartment 102. The firebox 200 further comprises a funnel-shaped bottom wall 203 that grease and oil dripped from the cook top 101 is guided at the bottom wall 203 of the firebox 200. A grease collector 107 is detachably mounted to the supporting frame 100 below the bottom wall 203 of the firebox 200 to collect the grease and oil dripped therefrom. The firebox 200 is shifted forwardly towards the front side 103 of the supporting frame 100 so that the user is able to reach and access the cook top 101 closely in comparison with the conventional grill that the firebox is shifted backward.

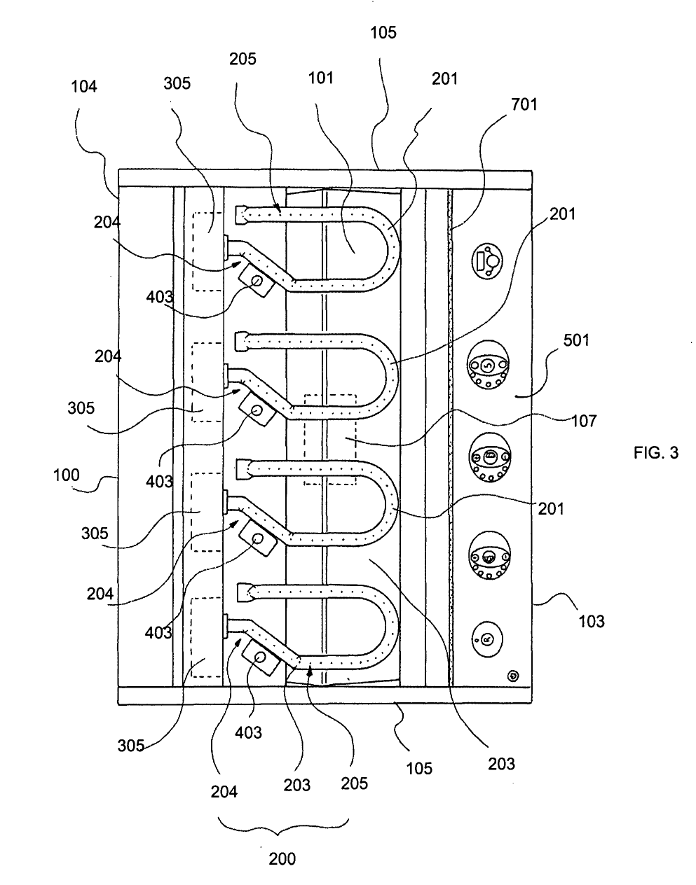

As shown in FIG. 3, each of the gas burners 201 comprises a gas tube 203 for the gas flowing therethrough. The gas tube 203 has a rear entrancing end 204 and a plurality of spaced apart gas holes 205 wherein the gas is guided to flow along the gas tube 203 from the rear entrancing end 204 and to exit at the gas holes 205. Each of the gas burners 201 generally has a U-shape defining one end as the rear entrancing end 204 and an opposed closed end wherein the gas holes 205 is evenly formed on the gas tube 203 between the rear entrancing end 204 and the closed end. One aspect of the gas burners 201 is that the gas is guided to flow from the rear entrancing end 204 so that the ignition of the emitting gas will be initially formed close to the rear entrancing end 204. When the user stands at the front side 103 of the supporting frame 100, the initial flame will be produced far away from the user.

As shown in FIGS. 1 and 4, the valve module 300 is supported at the rear portion of the bottom compartment 102 close to one of the sidewalls 105 of the supporting frame 100 to operatively link to the gas burners 201, wherein the ignition module 400 and the control module 500 are supported underneath the valve module 300 to operatively link with each other, so that the valve module 300, the ignition module 400, and the control module 500 provide an optimum pre-wiring routine for operation and reduce electrically influence thereamong. Protective layers are provided among the valve module 300, the ignition module 400, and the control module 500 to provide a water resistance thereof. The control module 500 is electrically linked with the valve module 300 and the ignition module 400 via a wiring structure 600 in which the wiring structure 600 is set in a pre-wiring manner to simplify the electrical configuration for assembling operation.

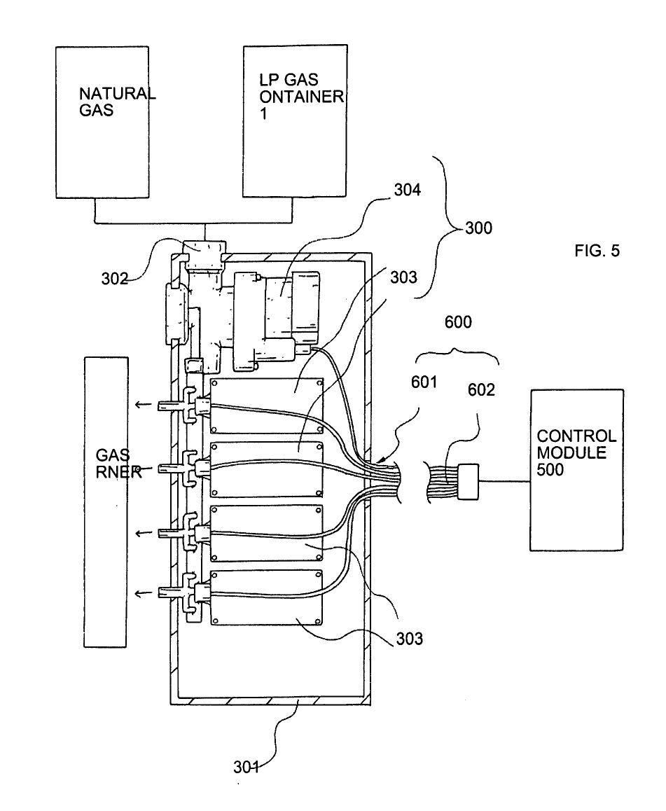

As shown in FIGS. 1 and 5, the valve module 300 comprises a valve box 301 supported at the rear portion of the bottom compartment 102, a gas inlet 302 for linking with a gas source, a plurality of gas controlling valves 303, and a safety valve 304. The gas controlling valves 303 are operatively linking from the gas inlet 302 to the gas burners 201 for controllably guiding the gas flow from the gas source to the gas burners 201 respectively. The safety valve 304 is supported within the valve box 301 to operatively link between the gas inlet 302 and the gas controlling valves 303. Preferably, each of the gas controlling valves 303 is linked to the respective gas burner 201 to regulate the gas flowing to the gas burner 201 via the respective gas controlling valve 303. One aspect of the present invention is that the gas controlling valves 303 and the safety valve 304 are protected within the valve box 301 as one of the integrated modules of the present invention. Therefore, the valve module 300 is pre-installed in one box for easily assembling operation and replacement. As shown in FIG. 5, the top wall of the valve box 301 is sealed with hole-less structure. The bottom wall of the valve box 301 has a wiring hole 601 wherein a pre-wiring cable 602 with a connector plug is electrically coupled with the gas controlling valves 303 and the safety valve 304 and is extended out of the valve box 301 through the wiring hole 601. Therefore, when the user cleans the cook top by water, the top wall of the valve box 301 blocks the water entering thereinto while the water cannot be entered into the valve box 301 through the wiring hole 601 at the bottom wall of the valve box 301. As shown in FIG. 1, the gas inlet 302 is operatively linked to a LP gas container 1 as the gas source via a LP hose with regulator. Alternatively, the gas inlet 302 can be operatively linked to the natural gas via a natural gas hose. Therefore, the user is able to select the use of LP gas or natural gas as the gas source for the gas grill apparatus.

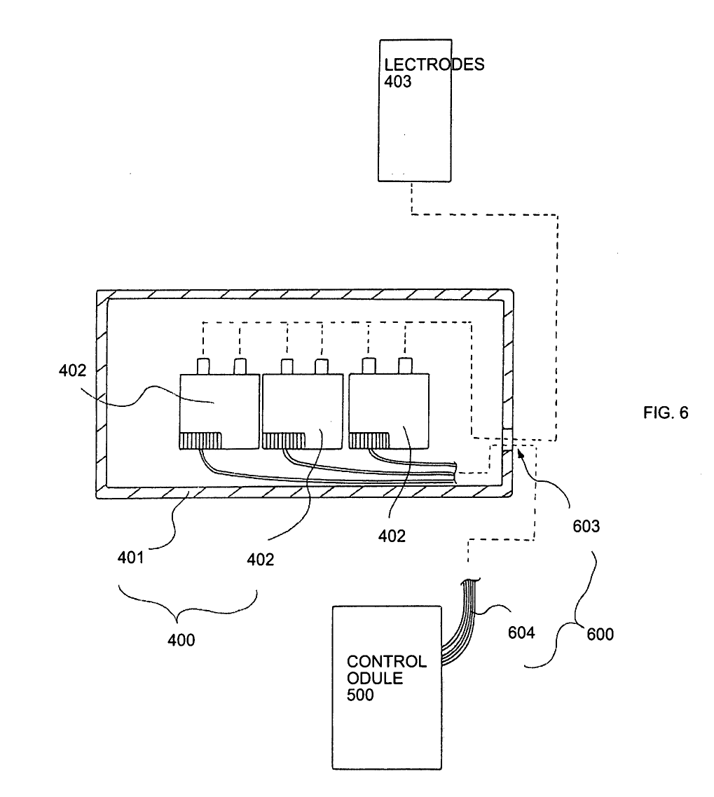

As shown in FIGS. 1 and 6, the ignition module 400 comprises an ignition box 401 supported at the rear portion of the bottom compartment 102 adjacent to the valve box 301, an ignition device 402 supported in the ignition box 401 to operatively link with the control module 500, and a plurality of electrodes 403 extended from the ignition device 402 to the cook top 101 close to the gas burners 201 respectively. The ignition device 402 comprises a plurality of igniters supported in the ignition box 401 and operatively linked to the electrodes 403 so that when each of the igniters is activated to electrify the respective electrode 403, the spark will be produced at the electrode 403 to ignite the gas emitting at the respective gas burner 201. As shown in FIG. 3, each of the electrodes 403 is positioned close to the rear entrancing end 204 of the respective gas burner 201 to initially ignite the gas from the rear entrancing end 204 of the gas burner 201. Another aspect of the present invention is that the ignition device 402 is protected in the ignition box 401 to operatively link with the control module 500 as another integrated module of the present invention. The user is able simplify the installation operation and replacement of the ignition module 400 to the supporting frame 100. As shown in FIG. 6, the top wall of the ignition box 401 is sealed with hole-less structure. For electrical wiring the ignition module 400, the bottom wall of the ignition box 401 has another wiring hole 603 wherein another pre-wiring cable 604 with a connector plug is electrically coupled with the ignition device 402 and is extended out of the ignition box 401 through the wiring hole 603. Therefore, when the user cleans the cook top 101 by water, the top wall of the ignition box 401 blocks the water entering thereinto while the water cannot be entered into the ignition box 401 through the wiring hole 603 at the bottom wall of the ignition box 401.

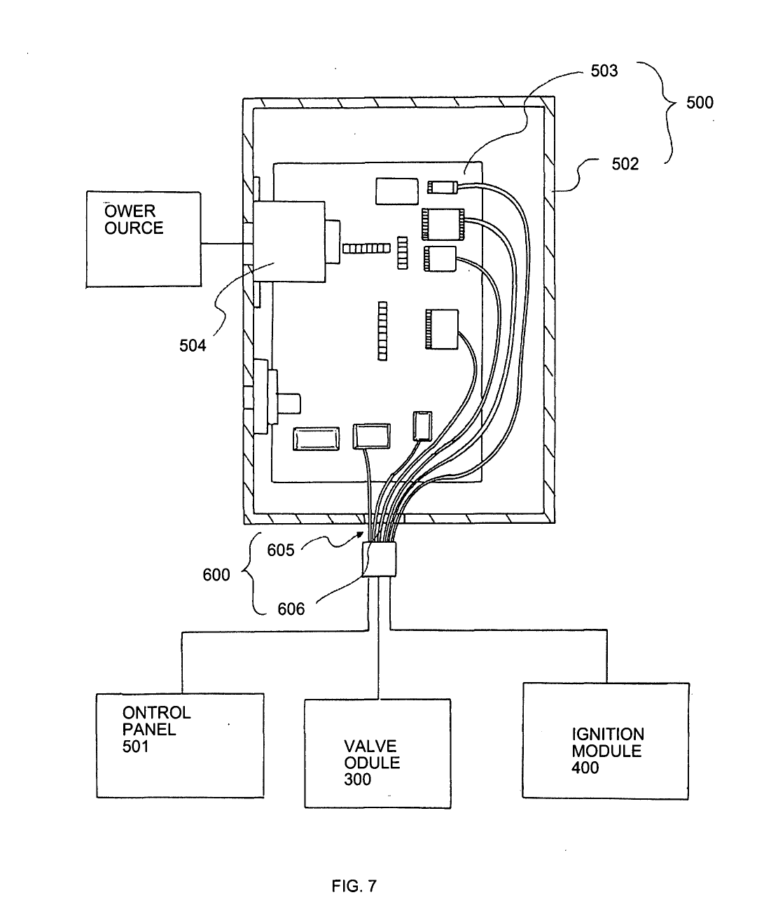

As shown in FIGS. 1 and 7, the control module 500 comprises a control panel 501 which is provided at the front side 103 of the supporting frame 100 and is operatively connected to the valve module 300 and the ignition module 400. The control panel 501 is actuated to control each of the gas controlling valves 303 to emit the gas from the respective gas burner 201 and, at the same time, to activate the ignition device 402 to produce the spark at the electrode 403 so as to ignite the gas emitting from the respective gas burner 201. The control module 500 further comprises a control box 502 supported at the rear portion of the bottom compartment 102 close to the valve module 300 and an ICB (Integrated Circuit Board) control 503 which is supported in the control box 502 to link with the control panel 501 and is operatively connected to the valve module 300 and the ignition module 400 in a pre-wiring connection to adjustably control an amount of the gas flowing to the gas burners 201 and to activate the ignition device 402 for ignition. The control module 500 further comprises a transformer 504 electrically connecting with a power source. As shown in FIG. 1, the control panel 401 has a touch control side operatively linked to the ICB control 503 for being activated by a touch of the user. The control panel 401 further contains a plurality of touch switches provided on the touch control side to adjust the gas flows to the gas burners 201 through the gas controlling valves 303 respectively and to control the ignition device 402 to generate the sparks at the electrodes 403 respectively. Therefore, the user is able to touch and press at each of the touch switches to ignite the gas emitting at the respective gas burner 201 and to adjust the level of the flame by controlling the amount of gas flowing to the gas burner 201. A backlight is provided at the touch control side for illumination of each of the touch switches. The touch switches are configured with C/F capacity type to eliminate the electrically switching contact of each of the switches and to minimize the mechanically operational failure so as to prolong the service life span of the control panel 401. The touch control side of control panel 401 is waterproof so that the control panel 401 can also be operated or actuated when water, dirt or grease is stuck on the touch control side of control panel 401.

In order to control the ignition device 402, one of the touch switches is configured to be touch to activate the corresponding ignition device 402 to produce the spark at the electrode 403. The ICB control 503 will continuously activate the ignition device 402 for spark generation for a predetermined time period, such as three seconds. The ICB control 503 will also periodically check whether the flame at the respective gas burner 201 is extinguished or not. Once the flame at the respective gas burner 201 is extinguished, the ICB control 503 will automatically activate the corresponding the ignition device 402 to re-ignite the gas burner 201. If the gas burner 201 cannot be re-ignited by any reason, the ICB control 503 will automatically shut off the gas controlling valve 303 for safety purpose. Therefore, the control module 500 can prevent the gas leakage accidentally.

The ICB control 503 further contains a self-checking circuit to automatically detect the status of each of the components of the gas grill including the valve module 300, the ignition module 400 and the control module 500. Once the self-checking circuit detects the operational failure of the corresponding component, the ICB control 503 will send a corresponding failure signal or code to be displayed on the display screen at the touch control side of control panel 401. Therefore, the user will be notified which component of the gas grill is malfunctioned.

Having the micro controller chip configured with the ICB control 503, the built-in WDT (Watchdog Timer) will automatically restore the configuration of the ICB control 502 once the main chip of the ICB control 503 is downed or malfunctioned. The micro controller chip of the ICB control 503 will also control the safety valve 304 so that when the main chip is malfunctioned, the ICB control 503 will automatically shut off the safety valve 304 to stop the gas flowing to the gas burner 201.

Having a time circuit built-in with the ICB control 503, a timer control is also provided at the control panel 501 for control the gas flowing to each of the gas burners 201 in a timely manner. Therefore, the gas can be automatically shut off at a preset time period. A temperature control circuit can also be built-in with the ICB control 503 to control the grilling temperature at the firebox 200 by self-controlling the gas flow at the gas controlling valves 303. A cook logic circuit is part of the ICB control 503 to automatically determine the cooking style such as well done, rare or medium rare, and/or the food categories including weight of meat and vegetable according to the user preference.

According to the present invention, a remote control 505 is operatively linked with the ICB control 503, wherein the remote control 505 is wirelessly linked to the ICB control 503 by providing a signal detector 506 provided at the control panel 501. Therefore, the user is able to wireless control the ICB control 503 via the remote control 505 to wirelessly control the ignition of the gas grill via the ignition module 400, to wirelessly adjust the size of the flame via the valve module 300, to wirelessly set the cooking time via the timer control, and to wirelessly set the grilling temperature at the firebox 200 via the temperature control circuit. The wireless connection between the remote control 505 and the ICB control 503 can be through RF signal or infrared signal.

Another aspect of the present invention is that the ICB control 503 is protected in the control box 502 to operatively link with the valve module 300 and the ignition module 400 as another integrated module of the present invention. The user is able to simplify the installation operation and replacement of the control module 500 to the supporting frame 100. As shown in FIG. 7, the top wall of the control box 502 is sealed with hole-less structure. For electrically wiring the control module 500 with the valve module 300 and the ignition module 400, the bottom wall of the control box 502 has the third wiring hole 605 wherein the third pre-wiring cable 606 with a connector plug is electrically coupled with the ICB control 503 and is extended out of the control box 502 through the wiring hole 605. Therefore, when the user cleans the cook top 101 by water, the top wall of the control box 502 blocks the water entering thereinto while the water cannot be entered into the control box 502 through the wiring hole 605 at the bottom wall of the control box 502.

Referring to the present invention, the valve box 301, the ignition box 401 and the control box 502 are metal boxes with insulated separation to reduce the electrically influences (transient, static electricity, etc) from the gas controlling valves 303, the safety valve 304, the ignition device 402, and the ICB control 503. As shown FIG. 1, the valve box 301, the ignition box 401, and the control box 502 are supported at the rear portion of the bottom compartment 101 to create a front cavity for receiving the LP gas container 1 as the gas source. More importantly, the valve box 301 is supported at the rear portion of the bottom compartment 101 close to one of sidewalls 105 of the supporting frame 100 to operatively link to the gas burners 201, wherein the ignition box 401 and the control box 502 are supported underneath the valve box 301 to operatively link with each other via the first to third wiring cables 601, 603, and 605, so that the valve box 301, the ignition box 401, and the control box 501 provide an optimum pre-wiring routine for operation. Therefore, the user is able to self-install the gas grill apparatus by mounting the valve box 301, the ignition box 401 and the control box 502 to the supporting frame 100 and electrically connecting them together via the wiring structure 600. It would be safe for the user to self-install the gas grill apparatus because all the valves, igniters, and circuit board are individually grouped into different integrated modules. Therefore, it is hassle free for the user to only electrically connect the integrated modules by the wires. Also, the wires are all well organized to prevent the wires from being tangled during installation.

In one aspect, each of the valve module 300, the ignition module 400 and the control module 500 is replaceable so that if one of them is malfunction, the user is able to only disconnect the broken one and replace the one instead of replacing the entire gas grill apparatus. The manufacturing cost and process can be reduced and simplified through the unique configuration of the integrated modules.

In one aspect, all the valve box 301, the ignition box 401, and the control box 502 are supported at the rear portion of the bottom compartment 101, the firebox 200 is forwardly shifted close enough the control panel 501 to minimize a distance between the gas burners 201 and the control panel 501. As it is mentioned above, the forward shifting location of the firebox 200 allows the user to easily reach and access the cook top 101 and create a space at the rear side of the firebox 200 to couple the gas burners 201 at the rear entrancing ends 204 thereof. Accordingly, a heat insulator 701 is provided between the firebox 200 and the control panel 501 for blocking heat transferring to the control panel 501.

As shown in FIG. 4, a holding panel 703 is mounted on the rear wall of the supporting frame 100 to form a gap therebetween, wherein the valve box 301, the ignition box 401, and the control box 502 are mounted to the holding panel 703. Therefore, the first to third pre-wiring cables 602, 604, and 606 are detoured to the gap between the supporting frame 100 and the holding panel 703 and are connected with each other within the gap. So, the first to third pre-wiring cables 602, 604, and 606 cannot be access from the front side of the bottom compartment 102.

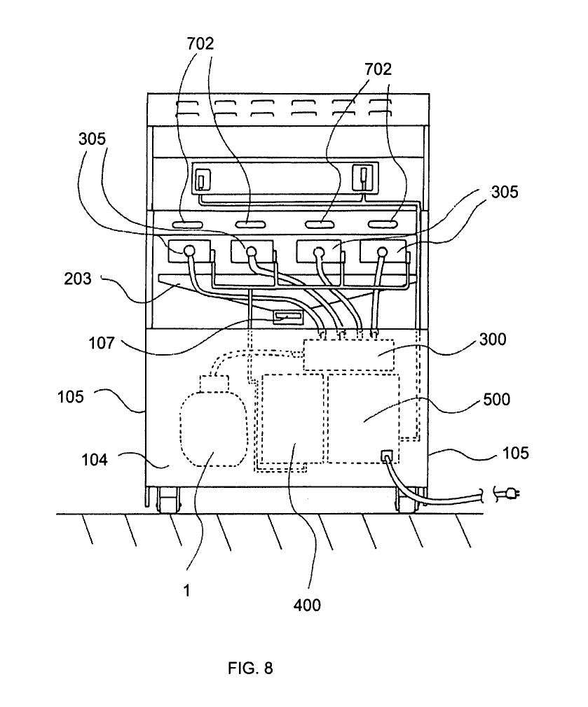

As shown in FIG. 8, the valve module 300 further comprises a plurality of orifices 305 which are operatively linked to the gas controlling valves 303 respectively and are spacedly mounted at the rear side of the firebox 200 to operatively couple with the rear entrancing ends 204 of the gas burners 201. Accordingly, the supporting frame 100 further comprises a rear cover 106 detachably mounted at a rear side of the supporting frame 100 to enclose and protect the orifices 305.

As shown in FIG. 8, the gas grill apparatus further comprises a plurality of spaced apart ventilation holes 702 provided at the rear side of the supporting frame 100 at a position above the bottom compartment 102 to align with the firebox 200 for better air circulation, wherein the ventilation holes 702 are located above the valve box 301, the ignition box 401, and the control box 502 for preventing overheat thereof. As shown in FIG. 8, the ventilation holes 702 are aligned in a horizontal orientation and located above the gas burners 201 to guide the heat discharging from the ventilation holes 702. Therefore, the heat from the firebox 200 can be released out of the supporting frame 100 through the ventilation holes 701 to prevent the heat being accumulated in the bottom compartment 102.

While the embodiments and alternatives of the present invention have been shown and described, it will be apparent to one skilled in the art that various other changes and modifications can be made without departing from the spirit and scope of the present invention.

What is claimed is:

1. A gas grill apparatus, comprising:
a supporting frame having a cook top and a bottom compartment,
a firebox supported by said supporting frame, wherein said firebox comprises a plurality of gas burners supported at said cook top above said bottom compartment;
a valve module, comprising a valve box supported at a rear portion of said bottom compartment, a gas inlet for linking with a gas source, and a plurality of gas controlling valves operatively linking from said gas inlet to said gas burners for controllably guiding a gas flow from said gas source to said gas burners respectively;
an ignition module, comprising an ignition device and a plurality of electrodes extended from said ignition device to said cook top close to said gas burners respectively; and
a control module, comprising a control panel which is provided at a front side of said supporting frame and is operatively connected to said valve module and said ignition module, wherein said control panel is actuated to control each of said gas controlling valves to emit said gas from said respective gas burner and, at the same time, to activate said ignition device to produce a spark at said electrode so as to ignite said gas emitting from said respective gas burner.

2. The gas grill apparatus of claim 1 wherein said ignition module further comprises an ignition box supported at said rear portion of said bottom compartment adjacent to said valve module, wherein said ignition device supported in said ignition box to operatively link with said control panel.

3. The gas grill apparatus of claim 1 wherein said control module further comprises a control box supported at said rear portion of said bottom compartment close to said valve module and an ICB control which is supported in said control box to link with said control panel and is operatively connected to said valve module and said ignition module in a pre-wiring connection to adjustably control an amount of said gas flowing to said gas burners and to activate said ignition device for ignition.

4. The gas grill apparatus of claim 2 wherein said control module further comprises a control box supported at said rear portion of said bottom compartment close to said valve module and an ICB control which is supported in said control box to link with said control panel and is operatively connected to said valve module and said ignition module in a pre-wiring connection to adjustably control an amount of said gas flowing to said gas burners and to activate said ignition device for ignition.

5. The gas grill apparatus of claim 3 wherein said control panel has a touch control side operatively linked to said ICB control for being activated by a touch of a user.

6. The gas grill apparatus of claim 4 wherein said control panel has a touch control side operatively linked to said ICB control for being activated by a touch of a user.

7. The gas grill apparatus of claim 6 wherein all said valve box, said ignition box, and said control box are supported at said rear portion of said bottom compartment to create a front cavity for receiving a LP gas container as said gas source.

8. The gas grill apparatus of claim 6 further comprising a wiring structure to operatively link said control module with said valve module and said ignition module, wherein said wiring structure contains a plurality of wiring holes provided at bottom walls of said valve box, said ignition box, and said control box respectively and comprises a plurality of pre-wiring cables extended from said gas controlling valves, said ignition device and said ICB control through said wiring holes respectively to electrically couple with each other behind said firebox.

9. The gas grill apparatus of claim 7 further comprising a wiring structure to operatively link said control module with said valve module and said ignition module, wherein said wiring structure contains a plurality of wiring holes provided at bottom walls of said valve box, said ignition box, and said control box respectively and comprises a plurality of pre-wiring cables extended from said gas controlling valves, said ignition device and said ICB control through said wiring holes respectively to electrically couple with each other behind said firebox.

10. The gas grill apparatus of claim 1 wherein said valve module further comprises a safety valve supported within said valve box to operatively link between said gas inlet and said gas controlling valves.

11. The gas grill apparatus of claim 9 wherein said valve module further comprises a safety valve supported within said valve box to operatively link between said gas inlet and said gas controlling valves.

12. The gas grill apparatus of claim 1 wherein said firebox is shifted forwardly towards said front side of said supporting frame to minimize a distance between said gas burners and said control panel, wherein a heat insulator is provided between said firebox and said control panel for blocking heat transferring to said control panel.

13. The gas grill apparatus of claim 4 wherein said firebox is shifted forwardly towards said front side of said supporting frame to minimize a distance between said gas burners and said control panel, wherein a heat insulator is provided between said firebox and said control panel for blocking heat transferring to said control panel.

14. The gas grill apparatus of claim 11 wherein said firebox is shifted forwardly towards said front side of said supporting frame to minimize a distance between said gas burners and said control panel, wherein a heat insulator is provided between said firebox and said control panel for blocking heat transferring to said control panel.

15. The gas grill apparatus of claim 1 wherein each of said gas burners comprises a gas tube having a rear entrancing end and a plurality of spaced apart gas holes, wherein each of said electrodes is positioned close to said rear entrancing end of said respective gas burner to initially ignite said gas from said rear entrancing end of said gas burner.

16. The gas grill apparatus of claim 6 wherein each of said gas burners comprises a gas tube having a rear entrancing end and a plurality of spaced apart gas holes, wherein each of said electrodes is positioned close to said rear entrancing end of said respective gas burner to initially ignite said gas from said rear entrancing end of said gas burner.

17. The gas grill apparatus of claim 14 wherein each of said gas burners comprises a gas tube having a rear entrancing end and a plurality of spaced apart gas holes, wherein each of said electrodes is positioned close to said rear entrancing end of said respective gas burner to initially ignite said gas from said rear entrancing end of said gas burner.

18. The gas grill apparatus of claim 15 wherein said valve module further comprises a plurality of orifices which are operatively linked to said gas controlling valves respectively and are spacedly mounted at a rear side of said firebox to operatively couple with said rear entrancing ends of said gas burners, wherein said supporting frame further comprises a rear cover detachably mounted at a rear side of said supporting frame to enclose and protect said orifices.

19. The gas grill apparatus of claim 16 wherein said valve module further comprises a plurality of orifices which are operatively linked to said gas controlling valves respectively and are spacedly mounted at a rear side of said firebox to operatively couple with said rear entrancing ends of said gas burners, wherein said supporting frame further comprises a rear cover detachably mounted at a rear side of said supporting frame to enclose and protect said orifices.

20. The gas grill apparatus of claim 17 wherein said valve module further comprises a plurality of orifices which are operatively linked to said gas controlling valves respectively and are spacedly mounted at a rear side of said firebox to operatively couple with said rear entrancing ends of said gas burners, wherein said supporting frame further comprises a rear cover detachably mounted at a rear side of said supporting frame to enclose and protect said orifices.

21. The gas grill apparatus of claim 6 wherein a plurality of ventilation holes are provided at a rear side of said supporting frame at a position above said bottom compartment to align with said firebox for better air circulation, wherein said ventilation holes are located above said valve box, said ignition box, and said control box for preventing overheat thereof.

22. The gas grill apparatus of claim 14 wherein a plurality of ventilation holes are provided at a rear side of said supporting frame at a position above said bottom compartment to align with said firebox for better air circulation, wherein said ventilation holes are located above said valve box, said ignition box, and said control box for preventing overheat thereof.

23. The gas grill apparatus of claim 20 wherein a plurality of ventilation holes are provided at a rear side of said supporting frame at a position above said bottom compartment to align with said firebox for better air circulation, wherein said ventilation holes are located above said valve box, said ignition box, and said control box for preventing overheat thereof.

24. The gas grill apparatus of claim 6 wherein said valve box is supported at said rear portion of said bottom compartment close to one of sidewalls of said supporting frame to operatively link to said gas burners, wherein said ignition box and said control box are supported underneath said valve box to operatively link with each other, so that said valve box, said ignition box, and said control box provide an optimum pre-wiring routine for operation and reduce electrically influence thereamong.

25. The gas grill apparatus of claim 14 wherein said valve box is supported at said rear portion of said bottom compartment close to one of sidewalls of said supporting frame to operatively link to said gas burners, wherein said ignition box and said control box are supported underneath said valve box to operatively link with each other, so that said valve box, said ignition box, and said control box provide an optimum pre-wiring routine for operation and reduce electrically influence thereamong.

26. The gas grill apparatus of claim 23 wherein said valve box is supported at said rear portion of said bottom compartment close to one of sidewalls of said supporting frame to operatively link to said gas burners, wherein said ignition box and said control box are supported underneath said valve box to operatively link with each other, so that said valve box, said ignition box, and said control box provide an optimum pre-wiring routine for operation and reduce electrically influence thereamong.

27. The gas grill apparatus of claim 4 wherein said control module further comprises a remote control wirelessly linked to said ICB control to wirelessly control said valve module and said ignition module.

28. The gas grill apparatus of claim 20 wherein said control module further comprises a remote control wirelessly linked to said ICB control to wirelessly control said valve module and said ignition module.

29. The gas grill apparatus of claim 26 wherein said control module further comprises a remote control wirelessly linked to said ICB control to wirelessly control said valve module and said ignition module.
